(19) United States
(12) Patent Application Publication
(10) Pub. No.: US 2022/0259920 A1
(43) Pub. Date: Aug. 18, 2022

(54) A DEVICE FOR PREVENTING BENDING OF LOWER ROTARY ROD AND WRINKLING OF FABRICS IN DOUBLE BLINDS WITHOUT STRINGS

(71) Applicant: Jae-Suk KWAK, Paju-si, Gyeonggi-do (KR)

(72) Inventors: Jae-Suk KWAK, Paju-si, Gyeonggi-do (KR); Woo-Jin KWAK, Paju-si, Gyeonggi-do (KR)

(73) Assignee: Jae-Suk KWAK, Paju-si, Gyeonggi-do (KR)

(21) Appl. No.: 17/627,566

(22) PCT Filed: Dec. 20, 2019
(86) PCT No.: PCT/KR2019/018178

§ 371 Date: Jan. 14, 2022

(30) Foreign Application Priority Data
Jul. 16, 2019 (KR) 10-2019-0085419

(51) Int. Cl. E06B 9/44; E06B 9/78

(52) U.S. Cl. CPC E06B 9/44; E06B 2009/801; E06B 9/78

(57) ABSTRACT

The present invention relates to a device for preventing bending of a lower rotary rod and wrinkling of fabric in double blind without a string. More specifically, while a lower case is moved downwardly by the force of a handle portion (250) being pulled, a pair of rollers and a lower rotary rod are rotated. The rollers having a smaller diameter than the lower rotary rod prevent the lower rotary rod from rising and at the same time offset the load while rotating in close contact with double fabric (240), and thus prevent bending of the lower rotary rod or wrinkling of the fabric.

### BACKGROUND OF THE INVENTION

### Technical Field

This invention relates to a device for preventing bending of lower rotary rod and wrinkling of fabrics in double blind without a string, and more particularly, to a device wherein as the lower case moves downward by the force pulling a handle portion and a pair of roller and the lower rotary rod are accordingly rotated, roller, with a smaller diameter than the lower rotary rod and being designed to be in close contact with the double fabric, prevents the lower rotary rod from rising and offset the loads loaded thereon, thereby preventing the bending of lower rotary rod and the wrinkling of the fabrics.

### Description of the Related Art

Generally, in order to adjust amount of light from window, various kinds of curtain or blinds such as venetian blinds, etc. have been used. Out of these kinds, curtain using a fabric that does not transmit light is used to control amount of light by covering a specific part of window selectively. However, these kind of curtain is problematic from the fact that it is difficult to control the entire light from the window because only the light of a specific part of the window blocked by the curtain was blocked.

In order to solve the above problems the general curtain have, zebra blinds or combination blinds that control the entire lighting from the window is used, in which the angle and position of the shielding member installed in the horizontal or vertical direction of the window is used to adjust entire lighting of the window.

These kinds of zebra and combination blinds uses a ball chain or string to adjust the angle and position of the shielding member. However, such usage of ball chain or string or the like parts for the blinds is not aesthetically good because it is dangling long from the blind. Further, because of usage of ball chain or string, unexpected cases such as accidents may occur while young children play with ball chains or strings around their necks, and in severe cases, dangerous situations that endanger life may occur.

In order to solve the aesthetic or safety problems the conventional zebra or combination blinds have, an utility model titled as “weight bar for roll blinds”, Korean Utility Model Publication No. 20-2010-0007482, has ever been introduced.

The utility model titled as weight bar for roll blinds, as shown in FIG. 1, introduce the weight bar located between blind fabric (7) and blind fabric (7) in order to stretch the blind fabric (7), the bar of which comprises support shaft (10) and case (20) for the support shaft (10) and fixing pin (30) for fixing support shaft (10) inserted into both ends of the case (20).

In above configuration, when the case (20) coupled to the support shaft (10) installed at the lower end of the blind fabric (7) is pulled downward, the blind fabric (7) and the support shaft (10) js rotated and the blind fabric 7 is lowered. However, in this utility model, as shown in the accompanying FIG. 2, the rotating support shaft (10) is bent by the load pulling the case (20) and accordingly blind fabric is also bent.

As described above, in the conventional configuration, the bending phenomenon of the blind fabric continuously occurs due to repeated usage so that there are problems that one side of the fabric is stretched or wrinkled, causing a problem in operation.

### CITATION LIST

### Patent Literature

(Patent Document 1) Korean Utility Model Publication No. 20-2010-00074628 titled as “weight bar for roll blinds”

### SUMMARY OF THE INVENTION

This invention is to solve the above-mentioned problems the conventional blinds have and its purpose is to prevent the lower case from being separated from the lower rotary rod while descending to the lower side. For the purpose, this invention is to provide device for preventing bending of lower rotary rod and wrinkling of fabrics in double blind without a string and specially characterized in that two rollers, which are smaller in diameter than the lower rotary rod, are positioned in close proximity to the lower rotary rod and allowed to be rotated and supported in close contact with the outer surface of the double fabric so as of the load to be offset, thus preventing the lower rotary rod from bending.

In order to achieve the above goal, the present invention is to provide a double blind without a string having a lower case, a lower rotary rod installed at the lower end of the double fabric and a closing cap installed at both ends of the lower case and it comprises lower case with engaging projections on its both upper sides, a handle portion coupled to the outer surface of the lower case, on the upper surface of which a roller housing to which the roller is fastened is formed symmetrically; a roller housing protruding outwardly on the upper surface of the handle, in which shaft coupling holes having shaft insertion holes is formed at both ends, roller grooves is formed between the shaft coupling holes and on the rear surface of the shaft coupling holes, protrusion grooves is formed; a roller inserted and installed in the roller housing; and is characterized in that when the lower case is coupled to the outer surface of the handle, the rollers are closely coupled to the outer surface of the double fabric, and the two of rollers as one pair are positioned with a width smaller than the diameter of the lower rotary rod to prevent bending of the lower rotary rod.

### BRIEF DESCRIPTION OF THE DRAWINGS

FIGS. 1 and 2 are enlarged cross sectional and perspective views showing the configuration of the inventor's previously registered patent

FIG. 3 is an exploded perspective view showing the overall configuration of the present invention

FIG. 4 is a side sectional view showing the configuration of the present invention

FIG. 5 is a perspective view showing the configuration of the handle part of the present invention

FIG. 6 is a perspective view showing a state in which the roller is coupled to the handle portion of the present invention

FIGS. 7 to 8 are perspective views showing the installation state of the handle portion of the present invention

FIG. 9 is a side sectional view showing an operating state of the present invention

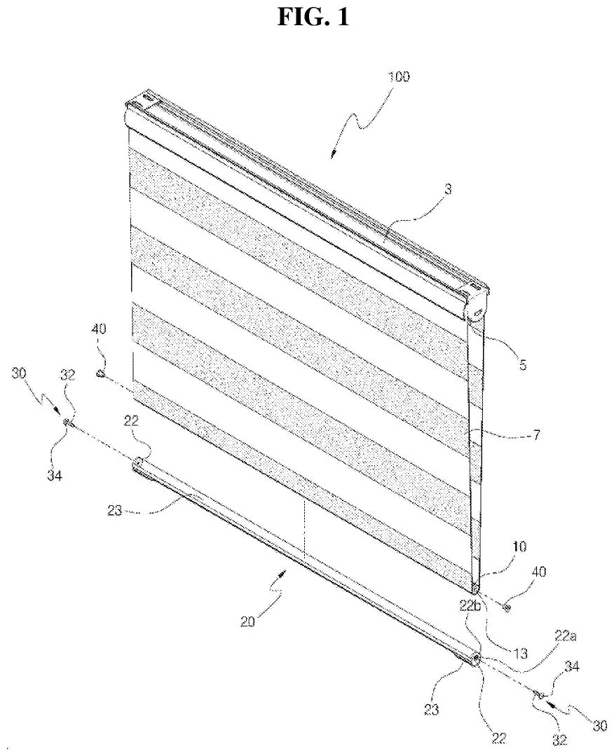

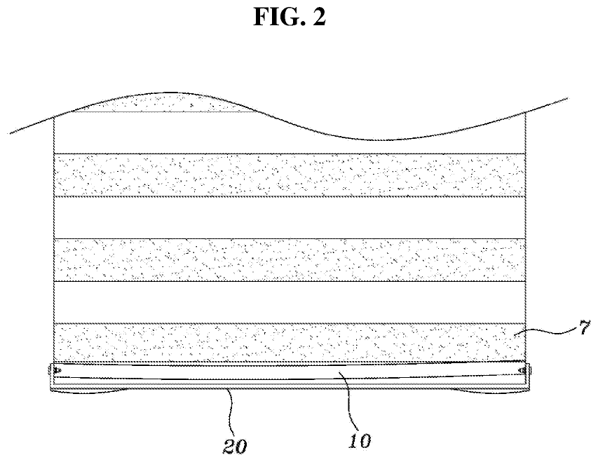

### PREFERRED EMBODIMENT OF THE INVENTION

Detailed description of the preferred embodiment of the present invention in conjunction with the accompanying drawings are as follows;

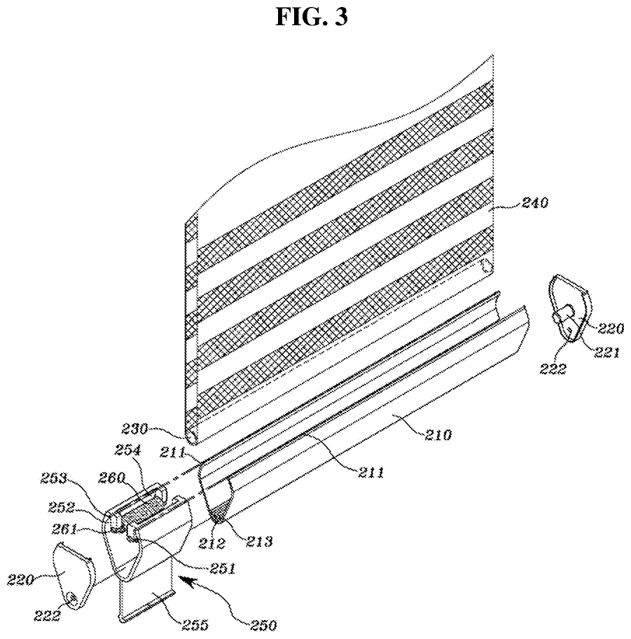

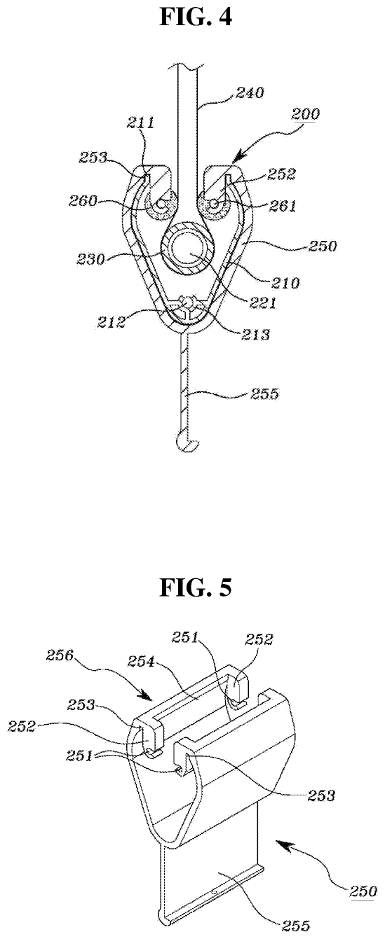

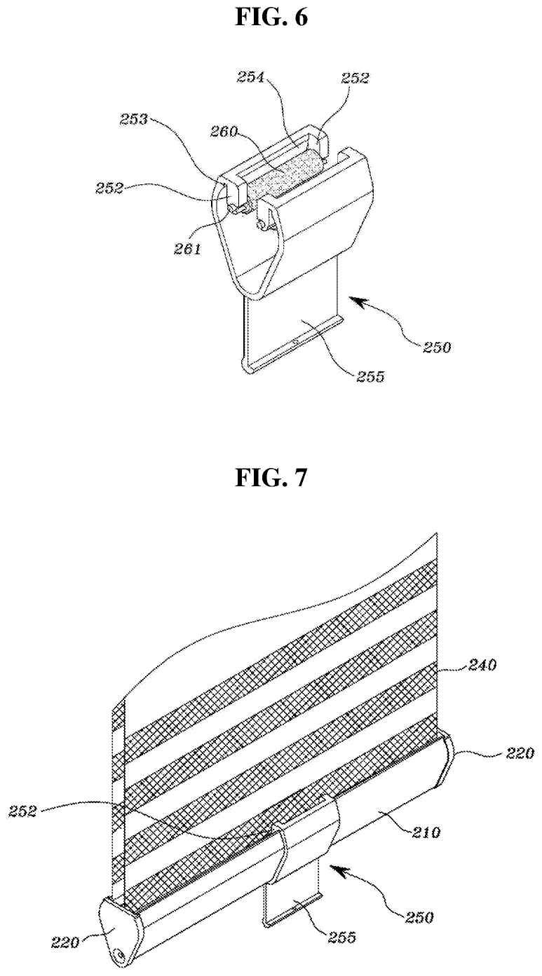

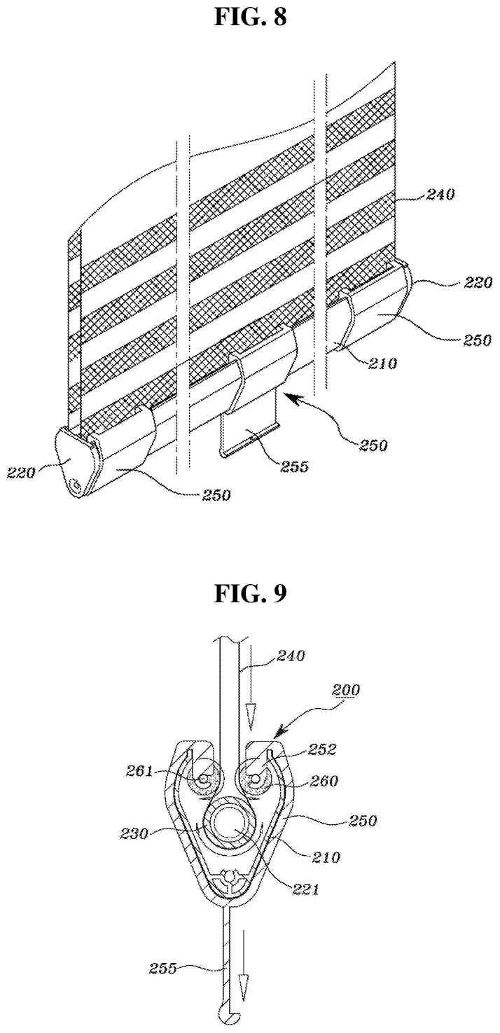

FIGS. 3 to 4 are exploded perspective and side cross-sectional views showing the overall configuration of the present invention and FIGS. 5 to 6 are the perspective views showing the configuration of the handle portion of the present invention. And, FIG. 7 to FIG. 8 are perspective views showing the installation state of the handle portion of the present invention in which FIG. 7 is a side cross-sectional view for showing the operation state of the present invention

In these drawings, reference numeral 200 indicate a device for preventing bending of the lower rotary rod and wrinkling of the fabric in the double blind without a string of the present invention.

A device for preventing bending of lower rotary rod and wrinkling of fabrics in double blinds without strings of this invention having a lower case (210), a lower rotary rod (230) installed at the lower end of the double fabric (240) and a closing cap (220) installed at both ends of the lower case (210) comprises a lower case (210) with coupling protrusions (211) formed on both upper sides; handle portion (250) coupled to the outer surface of above lower cases (210) having a roller housing to which a roller is fastened symmetrically formed on its upper part; roller inserted and installed in the roller housing; and is characterized in that when the lower case (210) is coupled to the outer surface of the handle portion (250), the roller (260), having a smaller diameter than the lower rotary rod with and being designed to be rotated in a state in close contact with the outer surface of double fabric (240), prevent the bending of lower rotary rod.

The lower case (210) is in a shape that the upper side, the left, and the right side are opened and its width is narrowed toward the lower side and further formed long in the longitudinal direction. The length of it can be cut arbitrarily.

And, on both sides of its upper end, the upwardly protruding coupling protrusion (211) is formed and the inner lower side of it is provided with a reinforcing protrusion (213) having a screw hole (212).

The closing cap (220) is a cap coupled to both ends of the lower case (210) in which circular shaft (221) protruding to the center from the center of it is formed and screw hole (222) is formed on the lower side of the shaft (221).

After matching the screw hole (212) of the screw hole (222) with the lower case (210), it is fixed by fastening the screw. And then, the lower rotary rod (230) installed at the lower end of the double fabric (240) is coupled to the circular shaft (221).

The inner tube of the handle portion (250), as show in accompanying drawing FIG. 5, is as same as the appearance of the lower case (210) and inside the upper surface of handle portion (250), the roller housings (256) into which the roller (260) is inserted are symmetrically formed, with protruding outwardly.

The roller housing (256) is located inside the upper surface of the handle portion (250) and in which the shaft coupling holes (252) having shaft insertion holes (251) protruding to the outside at both ends are symmetrically formed and between the shaft coupler (252) is provided with roller groove (254) into which the roller (260) is inserted.

And, on the rear surface of the shaft coupling hole (252), a projection groove (253) into which the coupling projection (211) of the lower case (210) is inserted is formed long in the longitudinal direction, and a handle (255) protruding downward on the lower side of the outer surface is formed.

The roller (260) has a shaft (261) protruding to the outside in the center of both sides and the shaft (261) is inserted into the shaft insertion hole (251) and the roller body (254) is inserted into roller groove (254), as shown in the accompanying drawings FIG. 6. Above two of the rollers (260) are a pair and are closely coupled to the outer surface of the double fabric (240).

The diameter of the roller (260) is formed smaller than the diameter of the lower rotary rod (230) and the distance between the roller (230) and the lower rotating rod (230) is about 2-3 mm.

In addition, the double fabric (240) coupled to the roller (260) and the lower rotary rod (210) is coupled in the form of an inclined line rather than a vertical.

The roller (260) is designed to be formed of a rubber material to minimize the friction coefficient generated during rotation in close contact with the double fabric (240).

In order to couple the handle portion (250) to the outer surface of the lower case (210), as shown in the accompanying drawing FIG. 7, the protrusion groove (253) of the handle part (250) is inserted into the both side coupling protrusions (211) of the lower case (210) and then pushed to position it in the center of the lower case (210).

At this time, the pair of roller (260) is in a state in close contact with the outer surface of the double fabric (240).

In addition, as shown in the accompanying drawing FIG. 8, both handle portion (250) without handle part (255) can be formed on the both ends of the outer surface of the case (210) instead of handle portion (250) with handle part (255).

The handle parts (250) installed at both ends of the lower case (210) not only prevent the both ends of the lower rotary rod (230) from being bent, but also help the double fabric (240) rotate uniformly and accordingly prevent wrinkling of the double fabric (240).

An embodiment of the present invention as described above will be described with reference to the accompanying drawings FIG. 3 and FIG. 9 as follows.

First, the lower rotary rod (230) installed at the lower end of the double fabric (240) is inserted into the circular shaft (221) of the closing cap (220). Then the lower rotary rod (230) rotates while being supported by the shaft (221).

The closing cap (220) is coupled to both ends of the lower case (210) and fixed by fastening the screws.

Then, after inserting the protrusion groove (253) of the handle part (250) into the engaging protrusion (211) of the lower case (210) and pushing it to one side, the handle portion is to be located in the center of the lower case (210).

If necessary, as shown in the accompanying FIG. 8, the handle portion (250) without the handle part (255) can be installed on both ends of the lower case (210).

At this time, a two of rollers (260) as one pair of the handle portion (250) is in a state in close contact with the outer surface of the double fabric (240).

The coupling protrusion (211) of the lower case (210) is inserted and coupled to the protrusion groove (253) of the handle (250) so that the handle (250) and the lower case (210) is moved integrally with each other.

When the handle portion (250) installed in the center of the lower case (210) is pulled downward, a pair of rollers (260) smaller than the diameter of the lower rotating rod (230) is rotated while in close contact with the double fabric (240), simultaneously with of lower rotary rod (230) being rotated and the lower case (210) is lowered.

At this time, the lower case (210) and the lower rotary rod (230) are about to spread by the pulling load of the handle part (250), but both because the distance between the lower rotary rod (230) and roller (260) is small and because a pair of rollers (260) smaller than the diameter of the double fabric (240) are rotated and supported in state in close contact with the double fabric (240) so that bending of the lower rotary rod (230) is prevented.

As above, since the upper and lower operations are stably performed without the double fabric (240) splayed or wrinkled, damage to the double fabric (240) is minimized and noise is also reduced.

In addition, because the pair of rollers (260) is made of a rubber material, it is possible to minimize the coefficient of rotational friction with the double fabric (240).

As described above, when the handle of the present invention is pulled downward, a pair of rollers and a lower rotary rod is rotated. At this time, a pair of rollers having a smaller diameter than the lower rotary rod block the rise of the lower rotary rod and offset the load loaded thereon while rotating in close contact with the double fabric, thus preventing the bending of the lower rotary rod and wrinkling of fabric. From the configuration, it also provides the effects that the damage to the double fabric is minimized and noise is also reduced.

In addition, it is also possible to obtain the effect of preventing the bending of both sides of the lower rotary rod by installing the handles without handle part on both ends of the lower case, thus preventing the bending of the both ends of lower rotary rod, simultaneously with allowing the double fabric to be rotated uniformly.

1. A device for preventing bending of lower rotary rod and wrinkling of fabrics in double blinds without strings having the lower case, lower rotary rod installed in lower part of double fabric and the closing cap installed on both ends of the lower case comprises;
a lower case with coupling protrusions formed on both upper sides;
a handle portion coupled to the outer surface of the lower case having a roller housing in the upper front surface to which roller is fastened is symmetrically formed;
a roller inserted and installed in the roller housing;
and characterized in that when the lower case is coupled to the outer surface of the handle, the roller, having a smaller diameter than the lower rotary rod and being designed to be rotated in a state in close contact with the outer surface of double fabric prevent the bending of lower rotary rod.

2. The device for preventing bending of lower rotary rod and wrinkling of fabrics in double blinds without strings of claim 1 is characterized in that the roller housing located inside the upper surface of the handle portion in which the shaft coupling holes having shaft insertion holes protruding to the outside at both ends are symmetrically formed and between the shaft couplers is formed with a roller groove into which the roller is inserted and protrusion grooves on the rear surface of shaft coupler is formed.

3. The device for preventing bending of lower rotary rod and wrinkling of fabrics in double blinds without strings of claim 1 is characterized in that the roller is formed of rubber.
